(19) United States
(12) Patent Application Publication
(10) Pub. No.: US 2026/0311511 A1
(43) Pub. Date: Oct. 8, 2026

(54) ADAPTIVE COMPREHENSION ENHANCEMENT SYSTEM

(71) Applicant: inFormed Consent LLC, Eden Prairie, MN (US)

(72) Inventors: Bradford C. Hancock, Eden Prairie, MN (US); Daniel R. Kloster, Fairway, KS (US); Jason Blake Penrod, Orlando, FL (US)

(21) Appl. No.: 19/098,497

(22) Filed: Apr. 2, 2025

(51) Int. Cl. G06V 40/16; G06F 21/84; H04N 21/442

(52) U.S. Cl. CPC G06V 40/172; G06F 21/84; H04N 21/44218

(57) ABSTRACT

Systems, methods, and computer-readable media for modifying a content package based on a comprehension level. A method may include capturing, during a viewing of the content package, a set of viewer data associated with a viewer of the content package, wherein the content package includes content and content delivery. The method may include verifying the viewer is an intended viewer of the content package. The method may include generating the comprehension level based on the content package, the set of viewer data, and the viewer. The method may include determining, an intervention for the content package based on the comprehension level, wherein the intervention is at least one of a first modification to the content or a second modification to the content delivery. A method may include modifying at least one element of the content package based on the intervention.

### BACKGROUND

### 1. Field

Embodiments of the present disclosure relate to interactive media systems. More specifically, embodiments of the present disclosure relate to adaptive content interactive media systems using artificial intelligence.

### 2.Related

Currently, the process of medical informed consent often relies on paper documents and static video explanations, which are often misunderstood by patients. Patient misunderstanding can lead to litigation and malpractice claims, particularly when patients claim they were not fully informed of the risks and outcomes of medical procedures. As such, healthcare providers may face frustration over these claims, especially in situations where the outcomes were known risks communicated through paper documents and static video explanations.

Many other fields face challenges from a lack of understanding of content, including the investment industry, medical device manufacturers, and research and development groups. For example, delivering compliance content and training may suffer from similar shortcomings. One cause of a lack of understanding may be a lack of real-time interaction for a viewer and comprehension checks. While current informed consent platforms may use recorded videos and forms, such videos provide no feedback on whether the viewer comprehends the material. Additionally, platforms are unable to adapt the content being delivered to a viewer before the viewer has moved on from the content. As such, content-delivery systems including comprehension feedback and adaptive content capabilities are desired.

### SUMMARY

In some aspects, the techniques described herein relate to one or more non-transitory computer-readable media storing computer-executable instructions that, when executed by a processor, perform a method for modifying a content package based on a comprehension level, the method including: capturing, during a viewing of the content package, a set of viewer data associated with a viewer of the content package, wherein the content package includes a content and a content delivery; verifying the viewer is an intended viewer of the content package; generating the comprehension level based on the content package, the set of viewer data, and the viewer; determining, an intervention for the content package based on the comprehension level, wherein the intervention is at least one of a first modification to the content or a second modification to the content delivery; and modifying at least one element of the content package based on the intervention.

In some aspects, the techniques described herein relate to one or more non-transitory computer-readable media, wherein if the viewer is not the intended viewer of the content package, initiating a pausing of a playback of the content.

In some aspects, the techniques described herein relate to one or more non-transitory computer-readable media, wherein verifying the viewer is the intended viewer of the content package includes: capturing an initial image of the viewer; capturing, during the viewing of the content package, a second image of a person viewing the content package; and determining, using a facial recognition algorithm, the person in the second image is identical to the viewer in the initial image.

In some aspects, the techniques described herein relate to one or more non-transitory computer-readable media, wherein generating the comprehension level further includes: analyzing at least one of a physical characteristic, an emotional characteristic, or an interaction pattern to determine the comprehension level of the viewer, wherein the physical characteristic, the emotional characteristic, of the interaction pattern are included in the set of viewer data.

In some aspects, the techniques described herein relate to one or more non-transitory computer-readable media, wherein the first modification includes a generated avatar reading a script of the content.

In some aspects, the techniques described herein relate to one or more non-transitory computer-readable media, wherein the second modification includes at least one of playback speed modification, closed captioning, or color contrast modification.

In some aspects, the techniques described herein relate to one or more non-transitory computer-readable media, further including: presenting a modified content package implementing the intervention to the viewer; receiving feedback on the modified content package; generating an updated comprehension level based on the feedback; and determining, based on the updated comprehension level, a second intervention, wherein the intervention is a first intervention.

In some aspects, the techniques described herein relate to a method modifying a content package based on a comprehension level, the method including: capturing, during a viewing of the content package, a set of viewer data associated with a viewer of the content package, wherein the content package includes a content and a content delivery; verifying the viewer is an intended viewer of the content package; generating the comprehension level based on the content package, the set of viewer data, and the viewer; determining, an intervention for the content package based on the comprehension level, wherein the intervention is at least one of a first modification to the content or a second modification to the content delivery; and modifying at least one element of the content package based on the intervention.

In some aspects, the techniques described herein relate to a method, further including: generating a ranking of a set of interventions including the intervention, wherein the ranking is based on a set of potential comprehension levels.

In some aspects, the techniques described herein relate to a method, Wherein the ranking of the set of interventions is personalized to the viewer.

In some aspects, the techniques described herein relate to a method, wherein the set of viewer data is captured in real time such that the at least one element of the content package is modified in real time.

In some aspects, the techniques described herein relate to a method, further including: presenting, in real time, a modified content package including the intervention; and modifying, in real time, the modified content package.

In some aspects, the techniques described herein relate to a method, further including: capturing a second set of viewer data based on a modified content package including the intervention; and generating a second comprehension level based on the second set of viewer data, wherein the set of viewer data is a first set of viewer data and the comprehension level is a first comprehension level.

In some aspects, the techniques described herein relate to a method, wherein the set of viewer data includes interface data, image data, and sensor data, wherein the sensor data includes at least one or gyroscope measurements, accelerometer measures, heart rate measurements, or temperature measurements.

In some aspects, the techniques described herein relate to a system for modifying a content package based on a comprehension level, the system including: a comprehension engine for generating the comprehension level based on a set of viewer data associated with the content package and a viewer of the content package, wherein the content package includes a content and a content delivery; a viewer interaction module for presenting the content package to the viewer and receiving the set of viewer data; an intervention engine for determining an intervention and modifying at least one element of the content package based on the intervention; and one or more non-transitory computer-readable media storing computer-executable instructions that, when executed by a processor, perform a method for modifying the content package based on the comprehension level, the method including: capturing, during a viewing of the content package, the set of viewer data associated with the viewer of the content package; generating, by the comprehension engine, the comprehension level based on the content package, the set of viewer data, and the viewer; determining, by the intervention engine, the intervention for the content package based on the comprehension level, wherein the intervention is at least one of a first modification to the content or a second modification to the content delivery; and modifying, by the intervention engine, the at least one element of the content package based on the intervention.

In some aspects, the techniques described herein relate to a system, wherein the comprehension engine further includes: a pattern recognition module for determining a pattern in a plurality of interactions the viewer has with the viewer interaction module; an emotional analyzer for analyzing an emotional characteristic from the set of viewer data; and a physical analyzer for analyzing a physical characteristic from the set of viewer data.

In some aspects, the techniques described herein relate to a system, wherein determining the comprehension level includes: determining the comprehension level based on the pattern, an emotional analysis performed by the emotional analyzer, and a physical analysis performed by the physical analyzer.

In some aspects, the techniques described herein relate to a system, wherein the intervention engine is a machine learning model trained to determine the intervention based on the comprehension level.

In some aspects, the techniques described herein relate to a system, the method further including: presenting, via the viewer interaction module, a modified content package implementing the intervention to the viewer; receiving feedback on the modified content package; generating an updated comprehension level based on the feedback; and refining the machine learning model based on at least one of the updated comprehension level or the feedback.

In some aspects, the techniques described herein relate to a system, further including: an avatar generation module for generating an avatar to present the content to the viewer, wherein the first modification includes the avatar, wherein the avatar depicts a medical professional associated with the content package.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein.

FIG. 1 depicts an exemplary hardware system in accordance with embodiments of the invention;

FIG. 2 depicts an exemplary content comprehension and intervention system in accordance with embodiments of the invention;

FIG. 3 depicts an exemplary comprehension monitoring system in accordance with embodiments of the invention;

FIG. 4 depicts an exemplary flowchart for illustrating the operation of a method in accordance with embodiments of the invention;

FIG. 5 depicts an exemplary intervention system in accordance with embodiments of the invention;

FIG. 6 depicts an exemplary learning system in accordance with embodiments of the invention; and

FIG. 7 depicts an exemplary flowchart for illustrating the operation of a method in accordance with embodiments of the invention.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

The following disclosure is directed to systems, methods, and computer-readable media for generating a comprehension level based on viewer data and modifying a content package with an intervention based on the comprehension level. A comprehension level is a value associated with a system-perceived understanding of a viewer with regard to a content package. A content package may include content and content delivery, where content is any media item, including written materials, videos, pictures, infographics, animations, podcasts, slideshows, interactive modules, tutorials, case studies, interviews, webinars, audio recordings, charts, social media posts, user guides, flowcharts, whitepapers, blog posts, datasets, reports, maps, and presentations. Content delivery refers to the elements surrounding the presentation of the content, such as playback speed, closed captioning, brightness, contrast, and any other similar setting. The system may be used in a variety of industries, including informed consent, compliance training, research study recruitment, and medical device training.

The system may include a comprehension engine, where the comprehension engine includes identity verification, pattern recognition, emotional analysis, and physical analysis in order to determine the comprehension level of a viewer with regard to a content package. The comprehension engine may use viewer data to generate a comprehension level, where viewer data relates to the viewing of the content package by a viewer. Viewer data may include data collected through interface interaction, sensor measurements, and image data. Interface data may include interactive elements such as comprehension quizzes and learning checkpoints. Said interactive elements may be voice-driven, gesture-based, and gaze-based responses, enabling viewers to interact with comprehension quizzes or learning checkpoints in a variety of ways. Image data may include photos and videos taken of the viewer during the viewing of the content package. The image data may be used to analyze emotion and verify identity as determined through facial recognition. Sensor data may include measurements taken by a plurality of sensors, the measurements relating to the physical and physiological state of the viewer.

Based on the generated comprehension level, an intervention engine of the system may determine and implement an intervention to increase the comprehension of the viewer. An intervention may be a modification to the content or delivery of the content, including modifications to playback speed, captioning, vocabulary, media type, language, avatar use, and any other modification. An intervention may be implemented in real time such that the content package on the client side is automatically replaced and/or updated with the modified content package. For example, if an AI avatar is delivering a video script for a video running on a client device (such as a cellphone or personal computer), when a modified content package with a modified script is received by the client device, the AI avatar may automatically deliver the modified video script to the viewer. By providing updates to content packages in real-time based on comprehension level, a lack of understanding of a viewer can be reduced or eliminated before the viewer finishes the viewing of the compliment and has to perform additional actions that rely on the understanding of the content, such as informed consent, research study participation, and compliant behavior.

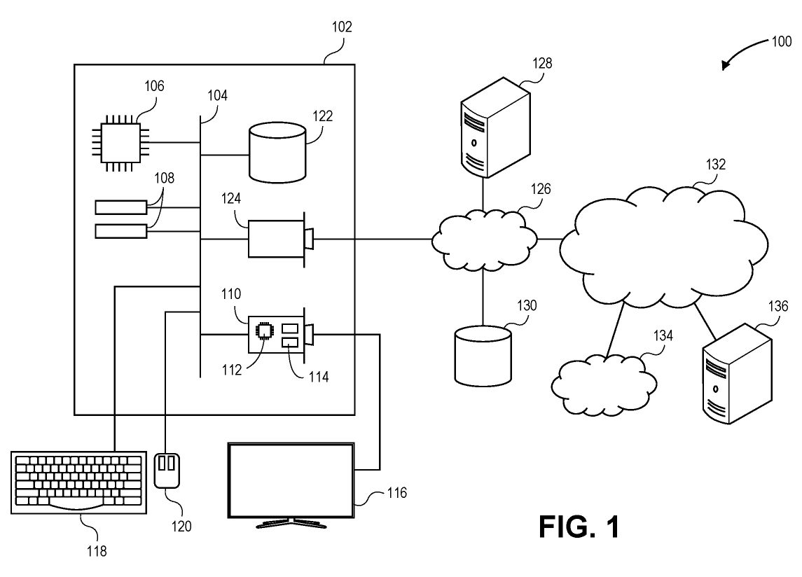

FIG. 1 illustrates an exemplary hardware platform relating to some embodiments of the present disclosure. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is a central processing unit, referred to herein as CPU 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for viewer interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removably attached.

Such non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, a network interface card, referred to herein as NIC 124, may also be attached to system bus 104 and allows computer 102 to communicate over a network such as local network 126. NIC 124 can be any form of network interface known in the art, such as Ethernet, ATM, fiber, Bluetooth®, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### Content Comprehension and Intervention Architecture

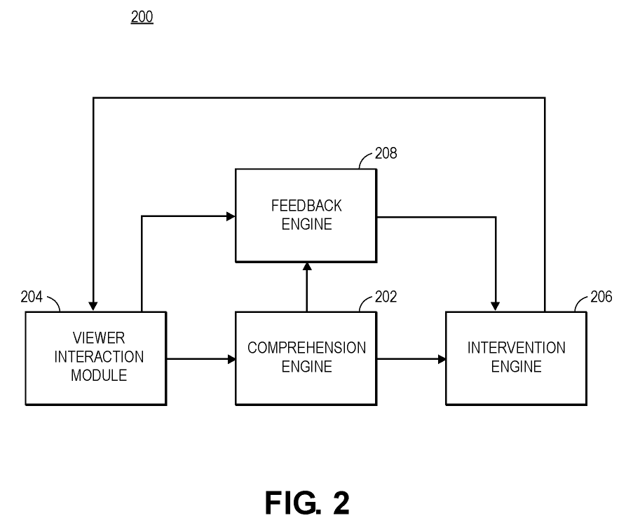

FIG. 2 depicts an exemplary content comprehension and intervention system in accordance with embodiments of the invention and generally referred to as system 200. System 200, in real time, assesses viewer comprehension through collected viewer data, generates a corresponding comprehension level, selects an intervention based on the comprehension level, and applies the intervention to a content package, where the intervention may be a modification to content or the content delivery. By modifying the content package based on viewer comprehension, system 200 increases the likelihood that a viewer understands the information presented to them through the content package. System 200 may include comprehension engine 202, viewer interaction module 204, intervention engine 206, and feedback engine 208.

In some embodiments, comprehension engine 202 receives viewer data from viewer interaction module 204. Broadly, viewer interaction module 204 presents a content package to and receives information from a viewer. Viewer interaction module 204 may interface with viewers through various platforms, including, but not limited to, e-learning systems, web browsers, applications, web applications, virtual environments, mixed reality environments, content-delivery systems, and other interfacing platforms. For example, viewer interaction module 204 may include a content-deliver application with an interactive user interface, where the user interface presents the viewer with content packages and the viewer inputs one or more pieces of information into the user interface. As such, viewer interaction module 204 may be facilitated on any client device now known or later developed, including, but not limited to, a personal computer, a cellular device, a tablet, a headset, headphones, an e-reader, a television, and similar devices.

In some embodiments, viewer interaction module 204 includes one or more sensors for measuring data associated with a viewer. Viewer interaction module 204 may collect a plurality of measurements associated with the physical state of a viewer. Examples of sensors interfacing with viewer interaction module 204 include, but are not limited to, heart rate monitors, gyroscopes, accelerometers, temperature sensors, infrared scanners, and other sensors. As discussed below, sensor measurements may provide comprehension engine 202 with a broader range of information when assessing the comprehension of a viewer as it relates to the physical state of the viewer.

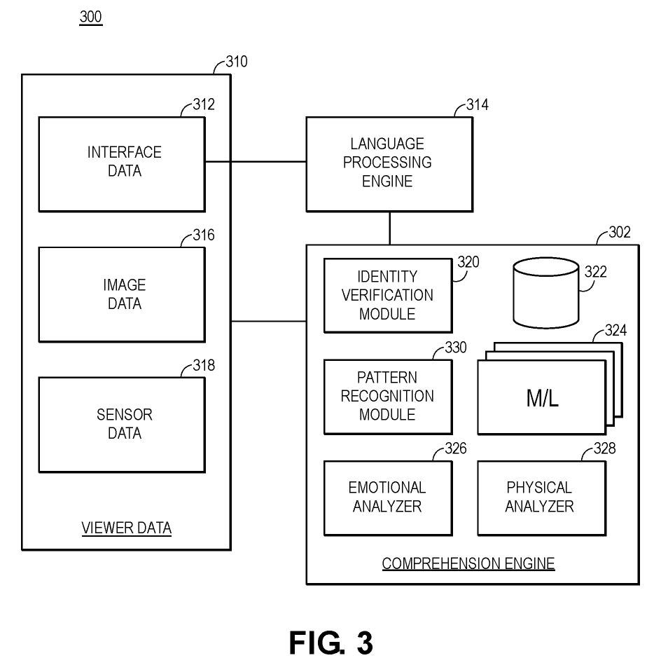

In some embodiments, viewer interaction module 204 captures image data associated with a viewer. For example, viewer interaction module 204 may include a camera for capturing images of the viewer. For another example, if viewer interaction module 204 is an integrated part of an application running on a mobile device, the front-facing camera of the mobile device may capture images of a viewer while the viewer views a content package. In some embodiments, image data includes video data. As such, comprehension engine 202 may utilize the image data to determine a comprehension level, as described below with regard to FIG. 3.

In some embodiments, system 200 includes comprehension engine 202. At a high level, comprehension engine 202 utilizes data from viewer interaction module 204 to assess viewer comprehension and verify identity to determine a comprehension level associated with a viewing of a content package by the viewer. For example, comprehension engine 202 may include identity verification, presence detection, emotional analysis, pattern analysis, and physical analysis. Accordingly, comprehension engine 202 may combine the results of identity verification, presence detection, emotional analysis, pattern analysis, and physical analysis to determine a comprehension level.

In some embodiments, comprehension engine 202 receives viewer data in the form of natural language, such as textual input. In such embodiments, comprehension engine 202 converts the natural language into computer-readable data points using natural language processing. For example, if input from viewer interaction module 204 is in the form of text input, comprehension engine 202 may use one or more natural language processing techniques to translate the text into data points usable for assessing comprehension level through processes such as emotional analysis. Natural language processing performed by comprehension engine 202 is discussed further below as it relates to language processing engine 314 depicted in FIG. 3.

In some embodiments, comprehension engine 202 performs identity verification and recognition to determine if the viewer is the intended viewer of the content package. By determining if the viewer is the intended viewer of the content package, comprehension engine 202 may assign a personalized comprehension level to a viewer for tailored modifications as well as build a profile for individual viewers, where historical data relating to a viewer may be used to refine comprehension engine 202 (such as through machine learning) to more accurately assign comprehension levels. Additionally, comprehension engine 202 may utilize results from identity verification and recognition to determine if the viewer is present within a camera frame for purposes of assessing comprehension. Identity recognition is discussed more below as it relates to identity verification module 320 depicted in FIG. 3.

Broadly, as mentioned above, comprehension engine 202 performs one or more analyses and aggregates the results of said analyses to assign a comprehension level to a viewing instance of a content package by a viewer. For example, if the viewer views a video relating to a medical procedure, comprehension engine 202 may assess a plurality of characteristics of the viewer during the viewing to determine a comprehension level associated with the viewer’s viewing of the medical procedure video. In some embodiments, comprehension engine 202 performs a pattern analysis on at least a portion of the viewer data received from viewer interaction module 204. For example, comprehension engine 202 may receive interface data, including data pertaining to the interface clicking of a viewer. As such, comprehension engine 202 may perform a pattern analysis to determine if there is any pattern of clicking that may indicate a characteristic pertaining to comprehension.

In some embodiments, comprehension engine 202 performs an emotional analysis on at least a portion of the viewer data received from viewer interaction module 204. For example, comprehension engine 202 may evaluate the facial expressions of a viewer as found in image data. Accordingly, comprehension engine 202 may use facial recognition algorithms to detect facial patterns associated with a lack of comprehension, such as a scrunched brow on the face of a viewer. For another example, comprehension engine 202 may evaluate whether a viewer was paying attention to the content package while the content package was being displayed. For example, comprehension engine 202 may detect the presence of the viewer by determining whether the viewer was captured in image data during a viewing of the content package. Additionally, comprehension engine 202 may perform gaze analysis by evaluating the line-of-sight of the user through image data to determine if the eyes of the viewer were gazing at the content during a viewing of the content. The emotional analysis performed by comprehension engine 202 is described more below as it relates to emotional analyzer 326.

In some embodiments, comprehension engine 202 performs a physical analysis on at least a portion of the data received from viewer interaction module 204. As discussed above, viewer interaction module 24 may capture one or more data points from sensors, such as from a gyroscope, temperature monitor, heart rate monitor, and any other monitor. Accordingly, comprehension engine 202 may assess the physical characteristics of a viewer exemplified through the captured sensor data. For example, if comprehension engine 202 detects a faster-than-average heart rate during a comprehension quiz meant to test the understanding of a viewer as it relates to the content, comprehension engine 202 may determine that the viewer may not have comprehended the information of the content. Conversely, if comprehension engine 202 detects an average heart rate during a comprehension quiz, comprehension engine 202 may determine that the viewer comprehends the information of the content and thus may assign a comprehension level accordingly. The physical analysis performed by comprehension engine 202 is described more below as it relates to physical analyzer 328.

In some embodiments, comprehension engine 202 aggregates analysis information received from the pattern recognition, emotional analysis, and physical analysis to assign a comprehension level to a viewer with regard to a content package. For example, a comprehension level of 0 may indicate that a viewer had no perceived understanding of content, while a comprehension level of 100 may indicate that the viewer had a complete perceived understanding of a content package. The assignment of a comprehension level is discussed further below as it relates to FIG. 3. The comprehension level generated by comprehension engine 202 may then be utilized by intervention engine 206 to select and implement an appropriate intervention for the content package presented to the viewer associated with the comprehension level.

Broadly, an intervention may be a modification to the content, the content delivery, or both the content and the content delivery of a content package. An intervention may serve to increase the comprehension level of a viewer with regard to a particular piece of content. Examples of interventions include speed reduction, closed captioning, text size adjustments, color adjustments, visual element modification, avatar adjustment, avatar presentation, content modification, and script modification. Interventions may be personalized to a viewer and a content package such that a particular intervention is implemented in a particular content package for a particular viewer. By tailoring interventions to particular viewers and particular content packages, intervention engine 206 may provide interventions that a particular viewer may be more likely to be receptive to, thereby increasing the probability that the viewer will comprehend a modified content package.

In some embodiments, intervention engine 206 ranks a set of interventions such that a particular intervention or subset of interventions corresponds to a given comprehension level. For example, intervention engine 206 may include a ranking of two interventions for a video, a first intervention changing the speed at which the video is played and a second intervention modifying the script of the video. The two interventions may be mapped such that a comprehension level between 50 and 99 corresponds to the first intervention, while a comprehension level between 0 and 49 corresponds to the second intervention. Accordingly, a viewer having a comprehension level of 73 may be presented with a content package with a speed-reduced video.

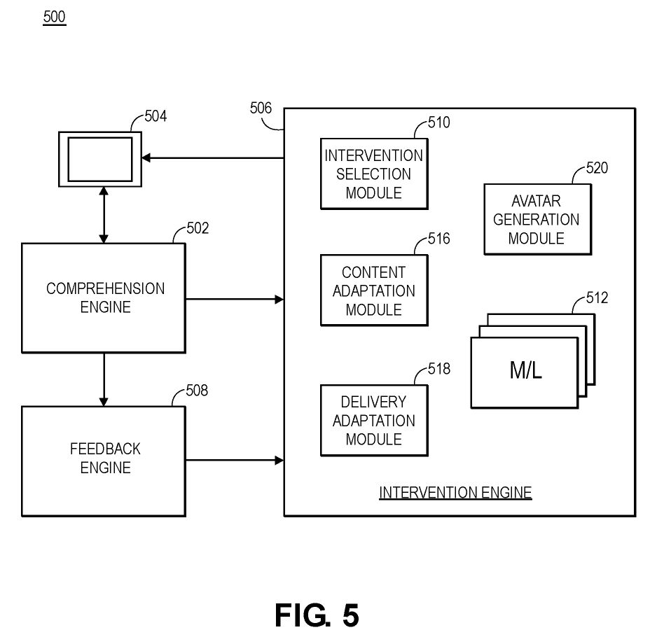

In some embodiments, upon selecting an intervention based on a comprehension level, intervention engine 206 may perform any number of actions to implement the intervention within the content package. For example, if the appropriate intervention is determined to be script modification, intervention engine 206 may interface with a content adaptation module, such as content adaptation module 516 depicted in FIG. 5, to modify the script of the content. For another example, if the appropriate intervention is determined to be a modification to the delivery of the content, intervention engine 206 may interface with a delivery adaptation module, such as delivery adaptation module 518 depicted in FIG. 5, to implement the delivery changes. For still another example, if the intervention is determined to be the addition of or a modification to an AI avatar presenting the content, intervention engine 206 may interface with an avatar generation module, such as avatar generation module 520 depicted in FIG. 5, to generate or modify an AI avatar.

After modifying the content package, intervention engine 206 may transmit the modified content package to viewer interaction module 204 for presentation to the viewer. For example, if the intervention is the addition of closed captioning and a reduction of speed of a video to .75x the original speed, intervention engine 206 may serve a closed captioned, reduced speed video to viewer interaction module 204 for presenting to the viewer, such as through a GUI. In some embodiments, as mentioned above, data may be received from viewer interaction module 204 in real time such that intervention engine 206 may modify content and/or delivery of the content while a viewer is viewing the content. For example, the modified content package may automatically replace the content package being presented to the viewer when the modified content package is received. For example, intervention engine 206 may slow down the video and add closed captioning before the viewer is finished watching the video. This proves advantageous, as system 200 may prevent a viewer from watching an entire video without understanding the information being communicated through the video, saving the viewer time and preventing further confusion.

It may be advantageous for intervention engine 206 to receive feedback on the effectiveness of a given intervention with regard to the viewer. As such, in some embodiments, system 200 includes feedback engine 208. Broadly, feedback engine 208 collects data on the effectiveness of interventions to improve future interventions. Effectiveness may be defined as an increase in the perceived comprehension of a viewer with regard to information being conveyed through a content package. For example, the effectiveness of a content package conveying information on a spinal procedure may be assessed by whether the viewer has a greater understanding of the spinal procedure viewing the modified content package rather than the unmodified content package.

Feedback collected by feedback engine 208 on the effectiveness of an intervention may be used to retrain intervention engine 206 (such as via machine learning) to determine more appropriate interventions for a given viewer and content package. For example, if feedback engine 208 provides information indicative of a particular intervention being ineffective with regard to the comprehension of a viewer, intervention engine 206 may refine one or more algorithms for the selection of an intervention based on the knowledge of the ineffective intervention.

Additionally, feedback engine 208 may interface with comprehension engine 202 to generate an updated comprehension level based on the comprehension feedback received from feedback engine 208. Upon receiving feedback from feedback engine 208 and/or an updated comprehension level from comprehension engine 202, intervention engine 206 may provide one or more additional interventions to a viewer through viewer interaction module 204. For example, if feedback engine 208 determines a viewer is still struggling to comprehend the information of the content after the speed of the video has been reduced to .75x speed, intervention engine 206 may determine that a speed reduction to .50x speed is an appropriate intervention.

### Comprehension Monitoring

FIG. 3 depicts an exemplary comprehension monitoring system in accordance with embodiments of the invention and generally referred to as comprehension monitoring system 300. comprehension monitoring system 300 may monitor the comprehension of a viewer with respect to a given content package, such as through physical analysis, emotional analysis, identity verification, and/or pattern recognition. For example, if a patient is reviewing a video to give informed consent for a medical procedure, comprehension monitoring system 300 may analyze the perceived comprehension of the patient with respect to the video to determine if the patient is informed about the medical procedure. For another example, if a research participant is reading a manual relating to a research study, comprehension monitoring system 300 may monitor the research participant while the research participant reads the manual to assess perceived comprehension.

As such, comprehension monitoring system 300 may include viewer data 310. Broadly, viewer data 310 may be any data gathered relating to a viewer viewing a particular content package in a particular instance. As described above, viewer data 310 may be collected by a viewer interaction module, such as viewer interaction module 204 depicted in FIG. 2. Viewer data 310 may be collected in real time, such as when the viewer is viewing a content package. As described below, viewer data 310 may be used to perform any number of analyses that may be combined to generate a comprehension level. Viewer data 310 may include information indicative of the intended viewer, the time the data was collected, and the corresponding content package being viewed while viewer data 310 was collected.

In some embodiments, viewer data 310 includes interface data 312. Interface data 312 may be data received from a viewer through a user interface. For example, interface data 312 may include textual inputs received in a text box of an interface associated with a content-providing system. Further, interface data 312 may include auditory data collected via a microphone, viewer selections on an interface, viewer clicks on an interface, viewer movement on an interface such as with a mouse, and other related data. To illustrate, an interactive content package providing information on a complex topic may be presented to a viewer through a user interface. After the viewer is presented with the interactive content package, a comprehension assessment may follow the interactive content package to test the comprehension of the viewer. Accordingly, interface data 312 may include information on where the viewer clicked on the interactive content package, the comprehension assessment questions, and the responses given by the viewer to the comprehension assessment questions, where the responses are in the form of multiple-choice selection responses, textual responses, auditory responses, or any other type of response.

In some embodiments, as mentioned above, interface data 312 may be in human-readable, natural language, such as in words, sentences, and paragraphs. In such embodiments, language processing engine 314 may translate the interface data 312 to computer-readable data points. Language processing engine 314 may be any machine learning model capable of receiving and translating natural language, including, but not limited to, a bag-of-word model, term frequency-inverse document frequency model, word embedding model, recurrent neural network model, convolutional neural network model, transformer-based model, seq2seq model, conditional random field model, latent Dirichlet allocation model, dependency parsing model, knowledge graph embedding model, hybrid model, rule-based NLP system model, large language model, or any other type of natural language processing model.

Language processing engine 314 may be trained using data sets specific to the topic of the content package being presented to the viewer. For example, if the content relates to a particular medical procedure, language processing engine 314 may be trained on a set of data relating to the medical procedure, such as commonly used phrases and words when discussing the medical procedure. In some embodiments, language processing engine 314 may be trained on a broader set of information. For example, if the viewer is being presented a content package in a system designed for general medical consent across a plurality of procedures and patients, language processing engine 314 may be trained using a data set including any and all medical procedures the system may request a patient to give informed consent for.

In some embodiments, viewer data 310 includes image data 316. Image data 316 may include images and or videos captured by a camera (or any other device capable of capturing image data 316), such as a front-facing camera on a cellular device. Image data 316 may relate to a viewer viewing a content package. For example, data may be captured during the presentation of a video to a viewer. For another example, a picture of a viewer may be captured for identification purposes, as described below. For still another example, image data 316 may include images and/or video data tracking the gaze of a viewer during the presentation of a content package. Accordingly, image data 316 may be used for identity verification, physical analysis, and emotional analysis. The uses for image data 316 are described further below with regard to identity verification module 320, emotional analyzer 326, and physical analyzer 328.

In some embodiments, viewer data 310 includes sensor data 318. Broadly, sensor data 318 may provide comprehension engine 302 with insights into the physical and emotional characteristics of a viewer that may indicate comprehension or lack of comprehension of a content package. Sensor data 318 may be captured by one or more sensors associated with the device displaying a content package to a viewer, such as a sensor within a computer device or a sensor interfacing with a computer device through a communication network, such as Bluetooth. In some embodiments, sensor data 318 may include a gyroscope measuring rotational motion. For example, a gyroscope within a cellular device may collect rotational motion information of a cellular device (or any other device) displaying the content to the viewer, where the rotational motion corresponds to hand tremors or fidgeting of a viewer. Said data may then be analyzed and attributed to the nervousness or confusion of the viewer, which may indicate a lack of comprehension of a viewer. In some embodiments, sensor data 318 may include data from an accelerometer. For example, an accelerometer may be used to monitor the hand gestures and movement of a viewer.

In some embodiments, sensor data 318 may include data from infrared sensors and laser range finders. For example, infrared sensors and laser range finders may be used to monitor the body language, posture, and position of a viewer while viewing a content package. Such monitoring may provide information indicative of disengagement, as shown through posture. In some environments, sensor data 318 may include temperature data. For example, sensor data 318 may include data from temperature sensors, such as temperature sensors performing facial temperature mapping based on a photo of the viewer. Additionally, facial temperature mapping may be performed by infrared sensors to determine if the viewer is embarrassed or stressed, as exemplified by facial temperature changes.

In some embodiments, sensor data 318 includes data from environmental sensors, such as geospatial location devices or microphones. For example, sensor data 318 may include data points relating to the location of a viewer as captured through geospatial location devices. For another example, sensor data 318 may include data points relating to the noise of the environment surrounding the viewer as captured by a microphone. By evaluating data associated with the environment of the viewer, comprehension engine 302 may assess whether a viewer is less likely to have comprehended the content package based on environmental distractions. In some embodiments, sensor data 318 includes data relating to heart rate variability, such as that determined by a heart rate monitor or a device capable of camera-based photoplethysmography (PPG). Measuring heart rate variability may provide insights into the stress or engagement levels of a viewer. Additional measurements in sensor data 318 may include the skin conductance levels and the respiration rate of a viewer.

As mentioned above, viewer data 310 may be provided to comprehension engine 302 in order for comprehension engine 302 to generate a comprehension level associated with a perceived comprehension of a viewer with respect to a content package. At a high level, comprehension of a given content package may be inferred by analyzing the identity, behavioral patterns, emotional states, and physical reactions of a viewer. Accordingly, comprehension engine 302 may utilize the trends of and interplay between identity, behavioral patterns, emotional states, and physical reactions to assign a comprehension level to a particular viewer with regard to a particular viewing of a content package. As such, comprehension engine 302 may include identity verification module 320, emotional analyzer 326, physical analyzer 328, and pattern recognition module 330.

In some embodiments, comprehension engine 302 may interface with identity verification module 320 to verify the identity of the viewer associated with viewer data 310. Identity verification module 320 may determine if the viewer associated with viewer data 310 is the intended viewer for a given content package. By doing so, comprehension engine 302 may ensure that the intended viewer of a content package is being analyzed, rather than an unintended viewer. This may be advantageous when multiple viewers are captured in image data, such as in a patient waiting room. Additionally, identity verification from identity verification module 320 may be advantageous when the identity of the viewer is important, such as in the case of informed consent contracts. The intended viewer of a content package may be specified in any number of ways, such as by a system administrator assigning a content package to a particular person.

In order to perform identity verification, identity verification module 320 may store a preliminary photo of the intended viewer and perform a comparison of the preliminary photo to the viewer pictured in photos received through image data 316. For example, when a viewer signs up for an application, identity verification module 320 may receive a preliminary photo and identify the person within the photo as the intended viewer, such as of certain content packages. Accordingly, during each subsequent login, a photo of the viewer may be captured and compared to the preliminary photo. As such, identity verification module 320 may employ facial recognition algorithms to determine if the face in the newly captured photo matches the face in the preliminary photo. Additionally, in some embodiments, facial recognition algorithms may be used to determine the presence of a viewer. Similarly to identity verification, presence detection may be used to verify that a viewer was viewing a content package while it was displayed. Presence detection may involve techniques similar to those performed for identity verification, such as image comparison. In some embodiments, presence detection includes picture-in-picture techniques, where the viewer can view themselves viewing a content package to determine if they are in the frame of a camera associated with the content delivery application.

In some embodiments, identity verification module 320 may store one or more identification data points of a viewer in viewer data store 322. For example, identity verification module 320 may store the preliminary image of the intended viewer in viewer data store 322 for subsequent access. Additionally, viewer data store 322 may store other information pertaining to a viewer, such as historical comprehension levels, account information, viewer preferences, content packages previously presented to the viewer, historical viewer data (such as interface, image, and sensor data), and other pieces of information. In some embodiments, viewer data store 322 may store information related to previous patterns, behavior, and emotional analyses conducted by comprehension engine 302, as described below. By storing the above information for later access, comprehension engine 302 may tailor comprehension level assessments to individual viewers.

As mentioned above, behavioral patterns of a viewer may be analyzed to determine a comprehension level of the viewer with respect to a content package. In some embodiments, comprehension engine 302 interfaces with pattern recognition module 330 to analyze behavioral patterns of a viewer. For example, pattern recognition module 330 may analyze behavioral patterns as they relate to a viewer's interaction with a user interface associated with a content-provider application. If the viewer is viewing a content package on a video platform, pattern recognition module 330 may analyze viewer behaviors such as clicks, mouse movements, page navigation, click frequency, and viewer-instigated page refreshing rates. By way of illustration, viewer data 310 may include data indicative of a viewer moving the mouse cursor on a user interface associated with the presentation of a content package twenty times in a thirty-second time frame during which a content package was being presented to the viewer. Accordingly, pattern recognition module 330 may receive said mouse cursor movement information, recognize the pattern of the viewer moving the mouse cursor twenty times in thirty seconds, and conclude the viewer may have been distracted or disengaged with the content package. As such, pattern recognition module 330 may provide information indicative of a lack of comprehension to comprehension engine 302 for assigning a comprehension level.

In some embodiments, comprehension engine 302 interfaces with physical analyzer 328 to assess comprehension as inferred through the physical condition of the viewer. Broadly, physical analyzer 328 analyzes facial expressions, eye movement, and physiological signals (e.g., heart rate variability, skin temperature) to determine characteristics pertaining to comprehension, such as cognitive load, confusion, or stress. In some embodiments, physical analyzer 328 evaluates the physical position and body posture of a viewer to infer comprehension. Physical analyzer 328 may use viewer data received from sensor data 318 and/or image data 316 to assess the posture and movement of a viewer. For example, slumped shoulders or restless movements may suggest disengagement or discomfort, which may indicate a lack of comprehension. Accordingly, images of the viewer may be used to determine if the shoulders of the viewer were slumped while the content package was being presented, or accelerometer data may show indications of the movements of the viewer.

As mentioned above, comprehension engine 302 may analyze the emotional characteristics of a viewer to infer the comprehension level of the viewer as it relates to a content package. In some embodiments, emotional analyzer 326 utilizes facial recognition and/or emotion detection algorithms to interpret expressions that indicate characteristics related to comprehension, such as confusion, frustration, interest, or understanding. For example, emotional analyzer 326 may evaluate muscular movement, eye movement, mouth movement, and other facial characteristics to look for signs of emotional state, such as furrowed brows, squinting eyes, or smiles. Emotional analyzer 326 may analyze viewer data 310, such as image data 316, for determining emotional state of a viewer. For example, if image data 316 includes a photograph of the viewer with a frown while the content package is being viewed, emotional analyzer 326 may determine that the viewer may not have understood the content of the content package.

In some embodiments, emotional analyzer 326 analyzes voice tone and speech patterns for comprehension. For example, emotional analyzer 326 may evaluate pitch, ton, speech rate, hesitations, changes in pitch, or stammering that may be a signal of confusion or uncertainty that may relate to comprehension. In such embodiments, emotional analyzer 326 may analyze sensor data 318, such as auditory data gathered during the presentation of the content package. In some embodiments, emotional analyzer 326 analyzes eye movement and gaze to determine comprehension. Broadly, frequent shifts in gaze or fixation on certain elements of a content package may indicate comprehension-related characteristics, such as focus or confusion. As such, emotional analyzer 326 may analyze the gaze of a viewer as determined through image and/or video data captured in image data 316.

Generally, more complex information in a content package may naturally result in physical and emotional changes in a viewer as compared to less complex information. As such, in some embodiments, emotional analyzer 326 and physical analyzer 328 may receive the content package to perform context analysis. For example, emotional analyzer 326 and physical analyzer 328 may determine the complexity of a content package relative to a predetermined metric, where the complexity of the content package is considered when determining what emotion and physical characteristics of a viewer say about the comprehension of the viewer.

In some embodiments, pattern recognition module 330, emotional analyzer 326, and/or physical analyzer 328 may utilize machine learning models 324 for analyzing patterns, emotional characteristics, and physical characteristics of viewer data 310, respectively, and relating said patterns, emotional characteristics, and physical characteristics to human comprehension. Machine learning models 324 may include supervised learning algorithms and/or deep learning networks. For example, machine learning models 324 may be convolutional neural networks (CNNs) for image-based data (e.g., facial expressions), recurrent neural networks (RNNs), and/or long short-term memory (LSTM) networks for time-series data (e.g., heart rate).

Machine learning models 324 may be trained on datasets containing labeled examples of emotional and physical responses as well as behavioral patterns associated with comprehension levels. In some embodiments, the datasets may include information pertaining to an individual viewer, such as physical and emotional response data tied to comprehension levels. Further, the training data may include results from comprehension assessments that provide information indicative of comprehension of a given content package. For example, machine learning models 324 may be trained on a data set including previously collected instances of viewer data 310 and the results of a comprehension assessment given to a viewer when viewer data 310 was collected.

In some embodiments, machine learning models 324 may be retrained to better correlate behavioral patterns, emotional characteristics, and physical characteristics to the perceived comprehension level of a viewer. For example, machine learning models 324 may be trained on information indicative of how close a perceived comprehension level of a viewer is to an actual comprehension of a viewer as shown through information such as comprehension assessments. For example, machine learning models 324 may be retrained on data sets including a comprehension level, viewer data 310, and comprehension assessments corresponding to the viewing of a content package associated with the comprehension level and viewer data 310.

In some embodiments, machine learning models 324 are anomaly detection models, allowing emotional analyzer 326, physical analyzer 328, and pattern recognition module 330 to determine anomalies in emotional characteristics, physical characteristics, and behavioral patterns, respectively. For example, if it the case that physical analyzer 328 determines the heart rate of the viewer is abnormal with respect to heart rate trends of the viewer as identified from previously collected heart rate measurements for the viewer, physical analyzer 328 may determine that the heart rate abnormality may correspond to a lack of understanding of the viewer.

After performing identity verification, a behavior pattern analysis, an emotional analysis, and/or a physical analysis, comprehension engine 302 may aggregate the results of the identity verification, a behavior pattern analysis, an emotional analysis, and/or a physical analysis to determine a comprehension level to associate with a viewing of the content package by the viewer. For example, one or more analyses may be represented as numerical values with associated weights, where the analyses are weighted against one another by comprehension engine 302 to determine a comprehension level. For example, comprehension engine 302 may use one or more algorithms to determine a comprehension level based on the results outputted by emotional analyzer 326, physical analyzer 328, and pattern recognition module 330. A comprehension level may be represented in any format, including a numerical value. For example, the comprehension level may be represented as a fraction or decimal value. For example, a comprehension level could be 50 out of 100, 5, or 1/2.

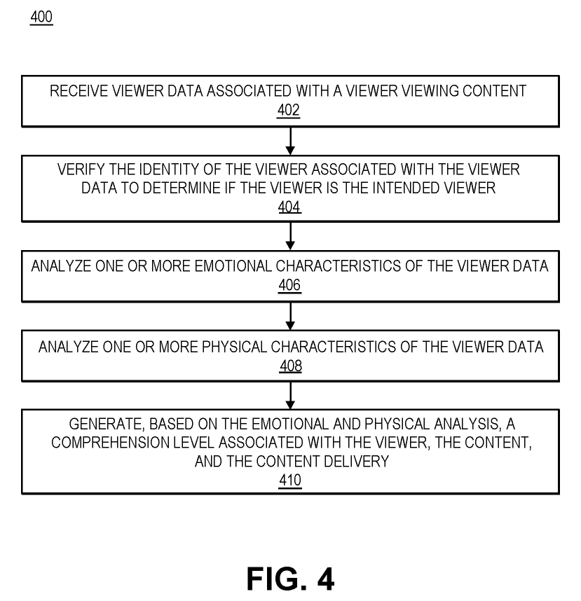

FIG. 4 depicts an exemplary flowchart for illustrating the operation of a method in accordance with embodiments of the invention and generally referred to as method 400. Broadly, method 400 is a method for determining the comprehension level associated with a viewer viewing a content package. Method 400 may be performed in part or in whole by system 200 and/or comprehension monitoring system 300. For example, comprehension engine 302 may determine a comprehension level according to method 400.

In step 402, viewer data associated with the viewer viewing a content package is received. Viewer data may include image data, interface data, sensor data, and any other data associated with viewing a content package by a viewer. For example, the viewer data may include video or camera data depicting the viewer, information relating to a viewer's interaction with a content viewing platform, heart rate information, gyroscope measurements, accelerometer information, and temperature information. As described below, the viewer data may be used to draw inferences about a viewer's perceived comprehension of a given content package for a particular viewing of the content package.

In step 404, the identity of the viewer associated with the viewer data is verified. As described above, the identity of the viewer may be verified to determine if the viewer is the intended viewer of the content. Such identification is advantageous, such as in informed consent contacts, where a patient must expressly give consent for a procedure, and legal consequences follow if informed consent is not given. Identity may be verified by comparing an image of the viewer with a previously verified image of the intended viewer. The identity of the viewer may also be verified by two-factor authentication, password input, and any other identity verification techniques

In step 406, one or more emotional characteristics of the viewer data are analyzed. As stated above, one or more emotional characteristics of the viewer may correspond to the viewer’s comprehension of the content package. For example, if a viewer is feeling nervous or upset, an emotional analysis may determine that the user likely did not comprehend the content package. Conversely, if the user is feeling content or happy, an emotional analysis may determine that the viewer likely did comprehend the content package. In some embodiments, machine learning is employed to analyze emotional characteristics captured in the viewer data and assign a value associated with comprehension to the emotional characteristics.

In step 408, one or more physical characteristics of the viewer data are analyzed. As mentioned above, one or more physical characteristics of the viewer may correspond to the viewer's comprehension of the content package. For example, if a viewer is fidgeting, has a racing heart rate, or has an above-average temperature, a physical analysis may determine that the viewer is distressed or distracted and, therefore, not comprehending the content package. In some embodiments, machine learning is employed to analyze physical characteristics captured in the viewer data and assign a value associated with comprehension to the physical characteristics.

In step 410, a comprehension level associated with the viewer and the content package is generated. As mentioned above, the comprehension level may be based on the emotional analysis performed in step 406, the behavioral analysis performed in step 408, a pattern analysis, a combination thereof, and any other analysis performed. The comprehension level may be a numerical value on a predetermined scale, the numerical value relating to the comprehension of a content package. The comprehension level may be generated using a model trained via machine learning, where the model is trained to draw relationships between physical characteristics, emotional characteristics, and patterns form to form inferences on the comprehension of the viewer.

### Adaptive Content System

FIG. 5 depicts an exemplary adaptive content system in accordance with embodiments of the invention and generally referred to as intervention system 500. At a high level, intervention system 500 modifies one or more elements of a content package based on the comprehension level of the viewer with respect to the content package. Intervention engine 506, generally related to intervention engine 206 depicted in FIG. 2, receives a comprehension level from comprehension engine 502, generally related to comprehension engine 302 depicted in FIG. 3. As mentioned above, the comprehension level may be a numerical representation of a perceived level of comprehension of a viewer as it relates to a content package presented to the viewer at a particular time.

Broadly, intervention engine 506 receives a comprehension level from comprehension engine 502, determines an intervention to modify the associated content package with, and serves the modified content package to the viewer through interface 504. Interface 504 may be any user interface for presenting a content package to a viewer, such as an interface served by a viewer interaction module, such as comprehension engine 202 depicted in FIG. 2. For example, interface 504 may be a graphical user interface presented on a phone application or computer application.

In some embodiments, intervention engine 506 includes intervention selection module 510 for selecting an intervention to modify a content package. For example, intervention selection module 510 may select one or more interventions from a predetermined list of possible interventions. Intervention selection module 510 may maintain a ranking of intervention techniques to select from based on a particular comprehension level. For example, intervention selection module 510 may rank and store intervention techniques for accessing when a comprehension level is received.

In some embodiments, intervention selection module 510 automatically ranks interventions. Interventions may be ranked by intervention selection module 510 according to any number of factors. For example, interventions may be categorized as passive interventions, active interventions, guided assistant interventions, and escalated support interventions. Passive interventions may be interventions involving the highlighting of key concepts, simplified summaries, and adjusted visual elements, such as modified font size, color contrast, or layout. Active interventions may include interactive explanations, detailed explanations, analogies, and examples, and the addition of AI-generated avatars, as discussed below. Guided assistant interventions may be interventions integrating adaptive quizzing, customized tutoring, and real-time content adaptation, as discussed below. Escalated support interventions may involve live expert help and collaborative learning, such as discussion groups. For another example of a ranking of interventions, intervention selection module 510 may rank interventions according to a corresponding comprehension level. For example, intervention selection module 510 may maintain categories of interventions, where a first category corresponds to comprehension levels between 0-25, a second category corresponds to comprehension levels between 26-75, and a third category corresponds to comprehension levels between 76-100.

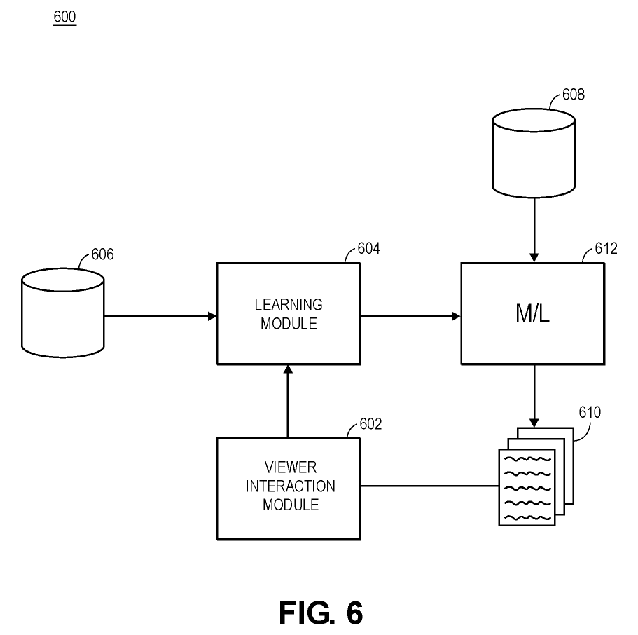

In some embodiments, intervention selection module 510 maintains a personalized ranking of interventions for a particular viewer. For example, a first viewer viewing a content package may have a first ranking from which intervention selection module 510 selects an intervention, while a second viewer viewing a content package has a second ranking from which intervention selection module 510 selects an intervention. In some embodiments, intervention selection module 510 uses machine learning model 512 to determine the ranking of interventions. For example, intervention selection module 510 may be a trained machine learning model for determining a ranking of interventions. For another example, intervention selection module 510 may be trained to anticipate future comprehension challenges, such that interventions that might overcome future comprehension challenges, as well as present comprehension challenges, are selected. In some embodiments, intervention selection module 510 may be a machine learning model capable of refining the ranking of interventions based on updated comprehension levels from comprehension engine 502 and feedback from feedback engine 508. The machine learning capabilities of intervention selection module 510 are discussed further below as they relate to FIG. 6.

Intervention engine 506 may select an intervention for a content package with an associated comprehension level based on the ranking of the intervention by intervention selection module 510. In some embodiments, if the determined intervention for a content package is content modification, intervention engine 506 interfaces with content adaptation module 516 in order to modify the content. Broadly, content adaptation module 516 alters substantive elements of the content, including, but not limited to, the script of the content, the objects being presented in the content, and other substantive elements.

In some embodiments, content adaptation module 516 interfaces with machine learning model 512 to alter one or more substantive elements of the content. For example, content adaptation module 516 may use natural language processing to alter the complexity of text within the content package. For example, if the comprehension level indicates a lack of understanding of a written content item, content adaptation module 516 may use natural language processing to alter the text of the written content item to replace complex language with more simplified language. For example, if a sentence of a content item states, “homo-sapiens are omnivores,” content adaptation module 516 may use natural language processing to modify the sentence to “humans eat both plants and animals.” In some embodiments, content adaptation module 516 integrates additional media forms into content as an intervention. For example, content adaptation module 516 may integrate videos, animations, written text, and infographics into a content package.

In some embodiments, content adaptation module 516 interfaces with avatar generation module 520 for generating avatars to present content to a viewer. Broadly, avatar generation module 520 utilizes machine learning model 512 to generate artificial intelligence avatars for delivering content, where an avatar presents a script as a talking head or as a full body with movement and gestures. For example, an AI avatar may present a script of a content package to a user through sign language. In some embodiments, a generated avatar corresponds to a real person associated with the content package. For example, if the content package is related to informed consent for a surgical procedure, the generated avatar may correspond to the surgeon performing the surgery such that the avatar resembles the image or likeness of the surgeon. In some embodiments, the AI avatar may be selectively determined by a viewer such that the viewer can select an avatar they want to hear the script from. This is advantageous, as the viewer can select an avatar that is most engaging and comforting, which may increase the comprehension levels of the viewer. As described above, the generated avatars may deliver content where the language, presentation, and pacing of the content are adapted in real time as further interventions are selected based on subsequently determined comprehension levels.

In some embodiments, intervention engine 506 interfaces with delivery adaptation module 518 to modify the delivery of a content package based on a comprehension level. For example, delivery adaptation module 518 may modify the speed of content delivery in audio or video formats. For another example, delivery adaptation module 518 may modify the language or provide a translation for the content being delivered.

Upon determining and implementing one or more interventions for a content package, the modified content package is presented to the viewer through interface 504. After presenting the modified content package to the viewer, the viewer may be monitored to determine how effective the modified content package is with respect to the viewer's comprehension. In some embodiments, feedback engine 508 collects feedback on the effectiveness of a modified content package and presents the feedback to intervention engine 506 for refinement of the interventions being implemented in the content package and or refinement of the model used to determine interventions or rank interventions.

In some embodiments, feedback engine 508 collects feedback in the form of an assessment. For example, feedback engine 508 may present a viewer with a quiz to test the viewer's comprehension. If the quiz results exceed a predetermined threshold, feedback engine 508 may provide information indicative of understanding to intervention engine 506. If the quiz results do not exceed the predetermined threshold, feedback engine 508 may provide information indicative of a lack of understanding to intervention engine 506.

In some embodiments, feedback engine 508 receives an updated comprehension level from comprehension engine 502. For example, if comprehension engine 502 receives an updated set of viewer data based on the modified content package, comprehension engine 502 may generate a new comprehension level based on an emotional analysis, identity verification, physical analysis, and/or pattern recognition. Accordingly, comprehension engine 502 may provide the updated comprehension level to feedback engine 508 and or intervention engine 506. Feedback engine 508 may then present the updated comprehension level and/or the feedback to intervention engine 506 for further refinement.

FIG. 6 depicts an exemplary learning system in accordance with embodiments of the invention and generally referred to as learning system 600. Learning system 600 is a machine learning model training system for determining an intervention ranking. In some embodiments, learning module 604 is operable to train machine learning model 612 to determine a ranking for a set of interventions. As described above, a ranking of a set of interventions may be determined by intervention selection module 510. In some embodiments, the ranking determined by intervention selection module 510 is personalized to a viewer, where the viewer is identified using an identity verification module, such as identity verification module 320 depicted in FIG. 3.

In some embodiments, learning module 604 receives training data from training data store 606. The training data received from training data store 606 may include data related to content, content delivery, and interventions. For example, the training data may include a mapping of comprehension levels to interventions that historically increased subsequent comprehension levels of content packages. In some embodiments, the training data received from training data store 606 is data specific to a viewer associated with a content package. For example, the training data may include viewer data, interface data, sensor data, and camera data, as discussed in FIG. 3. For another example, training data may include previous content packages, associated comprehension levels, and effective interventions associated with a viewer. As such, learning module 604 may train machine learning model 612 to select interventions that may be most effective for a given viewer rather than an average viewer.

In some embodiments, learning module 604 may train machine learning model 612 to rank interventions. Machine learning model 612 may be trained to rank interventions based on comprehension level, where a comprehension level input corresponds to an intervention output. For example, machine learning model 612 may be trained to select a content adaptation intervention when a comprehension level below 50 is received. In some embodiments, machine learning model 612 may be trained to rank interventions such that more aggressive interventions are assigned to lower comprehension levels as compared to interventions assigned to higher comprehension levels, where the aggressivity of an intervention corresponds to the amount of change applied to the content package. For example, if a first comprehension level indicates a greater level of understanding than a second comprehension level, machine learning model 612 may assign a pace change intervention to the first comprehension level and a total script redesign to the second comprehension level.

In some embodiments, after being trained, machine learning model 612 receives comprehension input 608 and determines one or more interventions 610 for a content package. Comprehension input 608 may include one or more comprehension levels, behavioral analysis, emotional analysis, identity information, and any other information relating to a content package presented to a viewer. As mentioned above, any number of interventions may be implemented for a given content package, including, but not limited to, content modification, delivery modification, and other interventions.

One or more interventions 610 may be determined by machine learning model 612, implemented within a content package, and presented to the viewer through viewer interaction module 602, generally corresponding to viewer interaction module 204 depicted in FIG. 2. As described above, an analysis may be performed on the effectiveness of a modified content package when presented to the viewer, such as whether the modified content package increased the comprehension level of the viewer. As such, in some embodiments, feedback and an updated comprehension level may be provided to learning module 604 for retraining of machine learning model 612. Machine learning model 612 may be refined to better determine one or more interventions 610 based on the effectiveness of previously implemented interventions for a content package. Additionally, machine learning model 612 may be refined to better tailor interventions to a viewer such that the interventions a particular viewer is receptive to are implemented.

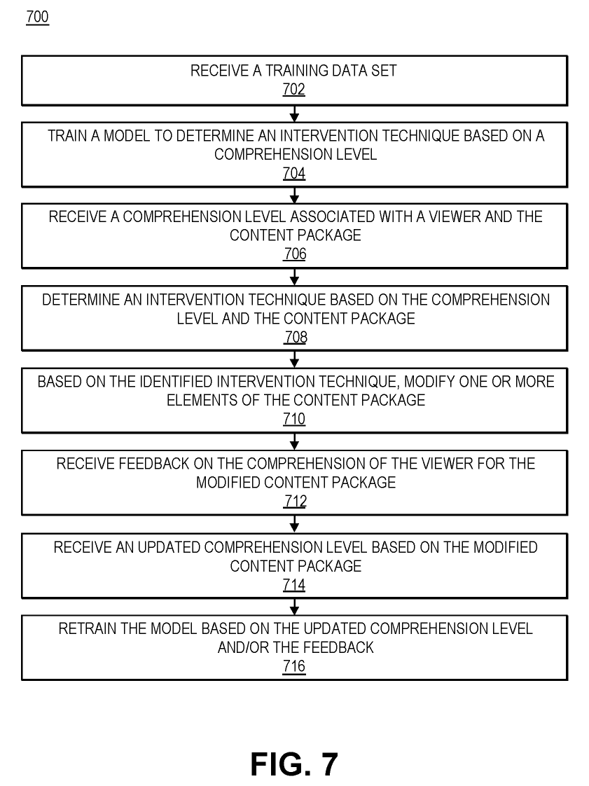

FIG. 7 depicts an exemplary flowchart for illustrating the operation of a method in accordance with embodiments of the invention and generally referred to as method 700. Broadly, method 700 is a method for determining an intervention using machine learning and modifying the intervention based on the effectiveness of the intervention when presented to a viewer. Method 700 may be performed wholly or in part by the systems depicted above, including system 200, comprehension monitoring system 300, and intervention system 500.

In step 702, training data is received. As discussed above, the training data may be historical information relating to content packages, the viewers viewing said content packages, the comprehension levels of said viewers, and the effectiveness of one or more interventions applied to the content packages. In some embodiments, the training data is specific to a viewer, whereas the training data includes information solely relating to the viewer. As such, a model may be trained to determine interventions that may be most effective for a particular viewer.

In step 704, a model is trained to determine an intervention technique based on a comprehension level. For example, the model may be trained to select one or more interventions from a set of predetermined interventions, where the selected one or more interventions are the interventions most likely to increase the comprehension level of a viewer with regard to a content package. For another example, the model may be trained to select one or more interventions from a set of predetermined interventions, where the model assesses the most likely interventions to be effective based on the average viewer rather than a specific viewer. In some embodiments, the model is trained to anticipate future comprehension challenges of the viewer and select one or more interventions accordingly.

In step 706, an intervention engine receives the comprehension level associated with the viewer and a content package. In some embodiments, the comprehension level is received from a comprehension engine, such as comprehension engine 302 depicted in FIG. 3. Broadly, the comprehension level may be associated with the viewer and a specific instance of viewing of the content package. For example, if a content package has been viewed a plurality of times by the viewer, the comprehension level may be associated with a first viewing from the plurality of viewings. This is advantageous, as it accounts for possible increases in comprehension levels for subsequent viewings of a content package that may lead to an underestimation of the comprehension level of a viewer if the comprehension levels of the viewer across the plurality of viewings are averaged into a single comprehension level.

In step 708, an intervention technique is determined based on the comprehension level and the present content package. In some embodiments, intervention techniques may be algorithmically mapped to comprehension levels such that a given comprehension level corresponds to the implementation of one or more interventions. As described above, an intervention may be a content adaptation, a content delivery adaptation, and/or an avatar generation. Additionally, a plurality of interventions may be determined for a content package, such as both a content adaptation and a content delivery adaptation. For example, interventions implemented in a content package may be the simplification of a script presented to the viewer as well as an AI generated avatar of the research director reading the simplified script. In step 710, one or more of the elements of the content package are modified according to the intervention technique identified in step 708. For example, the one or more interventions are implemented in the content package to receive a modified content package. The modified content package may then be presented to the viewer in real time.

In step 712, feedback on the viewer's comprehension of the modified content package is received. The feedback may be received from a feedback engine, such as feedback engine 508 depicted in FIG. 5. Feedback may be in the form of viewer data, such as interface data, image data, or sensor data, as well as comprehension assessment data, where a comprehension assessment is given to a viewer that tests the viewer's comprehension of the modified content package. The feedback may be used to determine what did and did not work about the one or more interventions used to modify the original content package.

In step 714, an updated comprehension level is received based on the modified content package. In some embodiments, the updated comprehension level is generated by a comprehension engine based on a set of viewer data associated with the modified content, including, but not limited to, interface data, image data, and sensor data. The updated comprehension level may be determined in the same fashion as that of previously determined comprehension levels for the original content package. The updated comprehension level may then be used to determine whether the viewer had a greater understanding of the information presented in the modified content package compared to the original content package.

In step 716, the model is retrained based on the updated comprehension level and feedback. For example, the model may be retrained to better determine an intervention technique for a given comprehension level based on the effectiveness of the previous intervention technique and the change to the comprehension level for a given content package. Additionally, the updated comprehension level, feedback, and updated model may be used to determine subsequent interventions to the modified content package to create a further modified content package.

Although the present disclosure has been described with reference to the embodiments illustrated in the attached drawing figures, it is noted that equivalents may be employed and substitutions made herein without departing from the scope of the present disclosure as recited in the claims and the following clauses:

Clause 1. One or more non-transitory computer-readable media storing computer-executable instructions that, when executed by a processor, perform a method for modifying a content package based on a comprehension level, the method comprising: capturing, during a viewing of the content package, a set of viewer data associated with a viewer of the content package, wherein the content package comprises a content and a content delivery; verifying the viewer is an intended viewer of the content package; generating the comprehension level based on the content package, the set of viewer data, and the viewer; determining, an intervention for the content package based on the comprehension level, wherein the intervention is at least one of a first modification to the content or a second modification to the content delivery; and modifying at least one element of the content package based on the intervention.

Clause 2. The one or more non-transitory computer-readable media of clause 1, wherein if the viewer is not the intended viewer of the content package, initiating a pausing of a playback of the content.

Clause 3. The one or more non-transitory computer-readable media of clause 1 or clause 2, wherein verifying the viewer is the intended viewer of the content package comprises: capturing an initial image of the viewer; capturing, during the viewing of the content package, a second image of a person viewing the content package; and determining, using a facial recognition algorithm, the person in the second image is identical to the viewer in the initial image.

Clause 4. The one or more non-transitory computer-readable media of any of clause 1 through clause 3, wherein generating the comprehension level further comprises: analyzing at least one of a physical characteristic, an emotional characteristic, or an interaction pattern to determine the comprehension level of the viewer, wherein the physical characteristic, the emotional characteristic, of the interaction pattern are included in the set of viewer data.

Clause 5. The one or more non-transitory computer-readable media any of clause 1 through clause 4, wherein the first modification comprises a generated avatar reading a script of the content.

Clause 6. The one or more non-transitory computer-readable media of any of clause 1 through clause 5, wherein the second modification comprises at least one of playback speed modification, closed captioning, or color contrast modification.

Clause 7. The one or more non-transitory computer-readable media of any of clause 1 through clause 6, further comprising: presenting a modified content package implementing the intervention to the viewer; receiving feedback on the modified content package; generating an updated comprehension level based on the feedback; and determining, based on the updated comprehension level, a second intervention, wherein the intervention is a first intervention.

Clause 8. A method modifying a content package based on a comprehension level, the method comprising: capturing, during a viewing of the content package, a set of viewer data associated with a viewer of the content package, wherein the content package comprises a content and a content delivery; verifying the viewer is an intended viewer of the content package; generating the comprehension level based on the content package, the set of viewer data, and the viewer; determining, an intervention for the content package based on the comprehension level, wherein the intervention is at least one of a first modification to the content or a second modification to the content delivery; and modifying at least one element of the content package based on the intervention.

Clause 9. The method of clause 8, further comprising: generating a ranking of a set of interventions including the intervention, wherein the ranking is based on a set of potential comprehension levels.

Clause 10. The method of clause 8 or clause 9, wherein the ranking of the set of interventions is personalized to the viewer.

Clause 11. The method of any of clause 8 through clause 10, wherein the set of viewer data is captured in real time such that the at least one element of the content package is modified in real time.

Clause 12. The method of any of clause 8 through clause 11, further comprising: presenting, in real time, a modified content package including the intervention; and modifying, in real time, the modified content package.

Clause 13. The method of any of clause 8 through clause 12, further comprising: capturing a second set of viewer data based on a modified content package including the intervention; and generating a second comprehension level based on the second set of viewer data, wherein the set of viewer data is a first set of viewer data and the comprehension level is a first comprehension level.

Clause 14. The method of any of clause 8 through clause 13, wherein the set of viewer data comprises interface data, image data, and sensor data, wherein the sensor data comprises at least one or gyroscope measurements, accelerometer measures, heart rate measurements, or temperature measurements.

Clause 15. A system for modifying a content package based on a comprehension level, the system comprising: a comprehension engine for generating the comprehension level based on a set of viewer data associated with the content package and a viewer of the content package, wherein the content package comprises a content and a content delivery; a viewer interaction module for presenting the content package to the viewer and receiving the set of viewer data; an intervention engine for determining an intervention and modifying at least one element of the content package based on the intervention; and one or more non-transitory computer-readable media storing computer-executable instructions that, when executed by a processor, perform a method for modifying the content package based on the comprehension level, the method comprising: capturing, during a viewing of the content package, the set of viewer data associated with the viewer of the content package; generating, by the comprehension engine, the comprehension level based on the content package, the set of viewer data, and the viewer; determining, by the intervention engine, the intervention for the content package based on the comprehension level, wherein the intervention is at least one of a first modification to the content or a second modification to the content delivery; and modifying, by the intervention engine, the at least one element of the content package based on the intervention.

Clause 16. The system of clause 15, wherein the comprehension engine further comprises: a pattern recognition module for determining a pattern in a plurality of interactions the viewer has with the viewer interaction module; an emotional analyzer for analyzing an emotional characteristic from the set of viewer data; and a physical analyzer for analyzing a physical characteristic from the set of viewer data.

Clause 17. The system of clause 15 or clause 16, wherein determining the comprehension level comprises: determining the comprehension level based on the pattern, an emotional analysis performed by the emotional analyzer, and a physical analysis performed by the physical analyzer.

Clause 18. The system of any of clause 15 through clause 17, wherein the intervention engine is a machine learning model trained to determine the intervention based on the comprehension level.

Clause 19. The system of any of clause 15 through clause 18, the method further comprising: presenting, via the viewer interaction module, a modified content package implementing the intervention to the viewer; receiving feedback on the modified content package; generating an updated comprehension level based on the feedback; and refining the machine learning model based on at least one of the updated comprehension level or the feedback.

Clause 20. The system of any of clause 15 through clause 19, further comprising: an avatar generation module for generating an avatar to present the content to the viewer, wherein the first modification comprises the avatar, wherein the avatar depicts a medical professional associated with the content package.

Having thus described various embodiments of the present disclosure, what is claimed as new and desired to be protected by Letters Patent includes the following:

1. One or more non-transitory computer-readable media storing computer-executable instructions that, when executed by a processor, perform a method for modifying a content package based on a comprehension level, the method comprising:
capturing, during a viewing of the content package, a set of viewer data associated with a viewer of the content package, wherein the content package comprises a content and a content delivery;
verifying the viewer is an intended viewer of the content package;
generating the comprehension level based on the content package, the set of viewer data, and the viewer;
determining, an intervention for the content package based on the comprehension level, wherein the intervention is at least one of a first modification to the content or a second modification to the content delivery; and
modifying at least one element of the content package based on the intervention.

2. The one or more non-transitory computer-readable media of claim 1,
wherein if the viewer is not the intended viewer of the content package, initiating a pausing of a playback of the content.

3. The one or more non-transitory computer-readable media of claim 1,
wherein verifying the viewer is the intended viewer of the content package comprises:
capturing an initial image of the viewer;
capturing, during the viewing of the content package, a second image of a person viewing the content package; and
determining, using a facial recognition algorithm, the person in the second image is identical to the viewer in the initial image.

4. The one or more non-transitory computer-readable media of claim 1, wherein generating the comprehension level further comprises:
analyzing at least one of a physical characteristic, an emotional characteristic, or an interaction pattern to determine the comprehension level of the viewer,
wherein the physical characteristic, the emotional characteristic, of the interaction pattern are included in the set of viewer data.

5. The one or more non-transitory computer-readable media of claim 1,
wherein the first modification comprises a generated avatar reading a script of the content.

6. The one or more non-transitory computer-readable media of claim 1,
wherein the second modification comprises at least one of playback speed modification, closed captioning, or color contrast modification.

7. The one or more non-transitory computer-readable media of claim 1, further comprising:
presenting a modified content package implementing the intervention to the viewer;
receiving feedback on the modified content package;
generating an updated comprehension level based on the feedback; and
determining, based on the updated comprehension level, a second intervention, wherein the intervention is a first intervention.

8. A method modifying a content package based on a comprehension level, the method comprising:
capturing, during a viewing of the content package, a set of viewer data associated with a viewer of the content package, wherein the content package comprises a content and a content delivery;
verifying the viewer is an intended viewer of the content package;
generating the comprehension level based on the content package, the set of viewer data, and the viewer;
determining, an intervention for the content package based on the comprehension level, wherein the intervention is at least one of a first modification to the content or a second modification to the content delivery; and
modifying at least one element of the content package based on the intervention.

9. The method of claim 8, further comprising:
generating a ranking of a set of interventions including the intervention, wherein the ranking is based on a set of potential comprehension levels.

10. The method of claim 9,
wherein the ranking of the set of interventions is personalized to the viewer.

11. The method of claim 8,
wherein the set of viewer data is captured in real time such that the at least one element of the content package is modified in real time.

12. The method of claim 8, further comprising:
presenting, in real time, a modified content package including the intervention; and
modifying, in real time, the modified content package.

13. The method of claim 8, further comprising:
capturing a second set of viewer data based on a modified content package including the intervention; and
generating a second comprehension level based on the second set of viewer data, wherein the set of viewer data is a first set of viewer data and the comprehension level is a first comprehension level.

14. The method of claim 8,
wherein the set of viewer data comprises interface data, image data, and sensor data,
wherein the sensor data comprises at least one or gyroscope measurements, accelerometer measures, heart rate measurements, or temperature measurements.

15. A system for modifying a content package based on a comprehension level, the system comprising:
a comprehension engine for generating the comprehension level based on a set of viewer data associated with the content package and a viewer of the content package, wherein the content package comprises a content and a content delivery;
a viewer interaction module for presenting the content package to the viewer and receiving the set of viewer data;
an intervention engine for determining an intervention and modifying at least one element of the content package based on the intervention; and
one or more non-transitory computer-readable media storing computer-executable instructions that, when executed by a processor, perform a method for modifying the content package based on the comprehension level, the method comprising:
capturing, during a viewing of the content package, the set of viewer data associated with the viewer of the content package;
generating, by the comprehension engine, the comprehension level based on the content package, the set of viewer data, and the viewer;
determining, by the intervention engine, the intervention for the content package based on the comprehension level, wherein the intervention is at least one of a first modification to the content or a second modification to the content delivery; and
modifying, by the intervention engine, the at least one element of the content package based on the intervention.

16. The system of claim 15,
wherein the comprehension engine further comprises:
a pattern recognition module for determining a pattern in a plurality of interactions the viewer has with the viewer interaction module;
an emotional analyzer for analyzing an emotional characteristic from the set of viewer data; and
a physical analyzer for analyzing a physical characteristic from the set of viewer data.

17. The system of claim 16,
wherein determining the comprehension level comprises:
determining the comprehension level based on the pattern, an emotional analysis performed by the emotional analyzer, and a physical analysis performed by the physical analyzer.

18. The system of claim 15,
wherein the intervention engine is a machine learning model trained to determine the intervention based on the comprehension level.

19. The system of claim 18, the method further comprising:
presenting, via the viewer interaction module, a modified content package implementing the intervention to the viewer;
receiving feedback on the modified content package;
generating an updated comprehension level based on the feedback; and
refining the machine learning model based on at least one of the updated comprehension level or the feedback.

20. The system of claim 15, further comprising:
an avatar generation module for generating an avatar to present the content to the viewer,
wherein the first modification comprises the avatar, wherein the avatar depicts a medical professional associated with the content package.
